(19) United States
(12) Patent Application Publication
(10) Pub. No.: US 2012/0005155 A1
(43) Pub. Date: Jan. 5, 2012

(54) Case management system with automatic document update

(75) Inventors: Arthur V. Lynch, Saddle River, NJ (US); James S. Lynch, Upper Saddle River, NJ (US)

(73) Assignee: Trial Attorney Support, Inc.

(21) Appl. No.: 12/803,694

(22) Filed: Jul. 3, 2010

(51) Int. Cl. G06F 17/30; G06F 3/048

(52) U.S. Cl. 707/608; 715/739; 707/E17.01

(57) ABSTRACT

A case management method is implemented by a computer processor for automatically controlling document-related operations within a plurality of data processing devices or computers connected and organized as an electronic network. The method includes automatically generating a request for an update file extension upon detection of a command to enter a document into the electronic network, inputting a response to the request including coding the document with an update file extension and entering and storing the document within the network in association with a filename identifier that includes the update file extension.

### FIELD OF THE INVENTION

The present invention relates to attorney case management systems and application programs broadly and more particularly, to a case management system with automatic document update ability and method for using same.

### BACKGROUND OF THE INVENTION

Personal injury plaintiff work concerns negligence-based legal practice from a plaintiffs position. Such practice typically includes that a client (i.e., the Plaintiff) retains a personal injury attorney or law firm on a contingency basis to represent them in a negligence-based suit for some type of injury. The attorney or law firm is paid only if there is a recovery for the client's injuries. The client's injuries are evidenced by treatment by doctors, dentists, physical therapists, chiropractors, psychiatrists, etc., which treatments have associated, costs to the client. The client typically seeks compensation for his/her injuries, medical-related costs other costs for negligence-related property damage (e.g., auto), pain and suffering, lost consortium, lost wages, etc.

In personal injury law practice, attorneys or trained staff-members typically spend hours to complete necessary forms and documents to move a case forward towards settlement. Letters are sent to the client, insurance companies, medical providers, opposing attorneys, the courts, etc. Once, a case is in the Courts, numerous legal documents must be prepared, exchanged with opposing counsel and presented to the Courts or Court clerks.

By automating the case handling and document production processes, various systems and applications are known that reduce the amount of time required to prepare and manage cases. By reducing the amount of time required to work up the average legal case, the profit margin can increase substantially and allow an attorney more time to spend investigating and preparing their cases and obtaining new clients. Known system and software applications are known as case management systems. Known case management systems include or cooperate with databases for storing and retrieving various relevant information, generating calendars of previously entered due dates, serving as contact managers and automatically processing billing and accounting matters.

While known case management systems all attempt to efficiently manage data in a personal injury plaintiffs law office network, not all are created and operate equally. For that matter, personal injury plaintiffs law office practice can be quite complex and network-based case management system control for which quite challenging. For example, in any given case, many clients with differing claims and injuries might be represented, and multiple defendants and third parties might be involved. Known case management systems are therefore hard pressed to provide for efficient data entry and management of the entire data representative of same, still less to provide for the efficient management of the data to effectively support the law firm in its representation once the data is entered.

As already mentioned, known case management systems generally comprise or cooperate with a relational database. A relational database normally includes two primary components: a database scheme and the data (i.e., a database instance) arranged in a collection of tables, each having a unique name. A row in a table represents a relationship among a set of values, so a table represents a collection of relationships. The database scheme is the logical design of how data is organized within the database, and includes the names of the tables, the names of the fields (or columns) within each table and the attributes of the fields (e.g., text, numeric, date, etc.). The database instance is the data in the database at a point in time.

U.S. Pat. No. 6,098,070, issued Aug. 1, 2000, discloses an electronic case manager for a personal injury plaintiffs law office including a relational database having a number of tables and a case management program for interfacing with a user to receive data, manage the data and to provide output. The electronic case manager includes a data structure programmed and arranged for classifying data in a relational structure and a database manager programmed and arranged for managing the data structure to allow users to generate documents on the output device. The relational structure comprises a plurality of tables, the tables comprising plural records relating to personal injury-causing incidents. Each record comprises at least one field.

Such a known case management system and application program, however, does not address that fact that most personal injury law firms are compelled to respond to such a high volume of incoming and outgoing communication that mistakes are inadvertently made. The value of the electronic case management system including the relational database is only as good as the quality of data in the database instance, and the ability to connect the data to the right person within the law firm responsible for taking appropriate action in response to the data. For that matter, appropriate action is conditioned upon the right person's ability to understand from the file data what the appropriate action is, in view of an instant state of a legal case.

While law firm employees can check on the status of an open legal case finding and picking through a paper file, sometimes referred to as a hard copy, they more and more rely on reading or accessing the set of electronic files comprising a legal case. Electronic files (i.e., documents and images of documents) comprising a legal case are typically stored together, or at least mapped together and viewed in a representative folder using a file manager such as Windows Explorer™. Law firm personnel may view the files in their file folder and/or sub-folders, and pick and choose which to click on and open.

Document management systems (DMS) operate in cooperation with computer system file managers, which typically provide a graphical user interface that allows users to access a file system (method of storing and organizing computer files and their data), for example, Windows Explorer™. The DMS provides shells or overlays that allow users to profile and arrange document files (referred to herein interchangeable as documents) and document (file) types in a relational database schema, for example, Worldox™ by World Software Corporation.

The documents or document files are stored either centrally at an Internet location (i.e., in the cloud), locally at an in-Network (intranetwork) location, or distributed partially intra- and/or Inter-network. In a Worldox™ application, the manager is called upon any time a document is saved to assign particular file management codes while concurrently creating a document profile. That is, a document profile is known to be created for each document that includes a description and comments about the document. In subsequent operation, the Worldox™ DMS or application allows a user to search for documents by searching the profiles.

Such electronic document files and their profiles, however, fail to provide a user with an instant feel for a state of a legal case. The user may readily search and find a document associated with a legal case if he/she knows a proper key word in the profile for the needed document, or if supported by the search engine, within the document itself. But even so, an ability to retrieve an individual document is a far cry from being able to understand the state of a case.

A case status or case profile may be generated with a description (e.g., Walker v. LIRR) and comments describing instant case activity (e.g., document production, outstanding action items x, y, z required/promised by Jun. 1, 2010, respectively, etc.). Hence, an attorney or support staff could access and read the legal case profile, not unlike an index typically found in paper legal case folders in order to determine what actions have been taken and what actions are required. But while relying on an electronic case profile managed by a case management system or application is preferred to accessing a paper file to glean a case status and outstanding action items, the quality of information in an electronic legal case profile is only as good as the information entered. That is, a significant drawback to viewing information entered in en electronic case management system, i.e., an electronic case profile (document), is that many times the information comprising the electronic case profile is incorrect or otherwise incomplete because it has not been entered properly.

Under such circumstances, reading an electronic record or profile describing a case or case record may be even less efficient and less effective for the personal injury firm as a whole than first finding and reading the actual paper records/data. It follows that even where a plaintiffs personal injury law firm practices in cooperation with conventional case management systems and the electronic records generated thereby, the firm's efficiency and effectiveness is not necessarily optimized.

Perhaps more importantly, however, even where individual document profiles and legal case status profiles are effectively completed (i.e., correct and accurate) and properly entered using a known case management system, such electronic documents and case status profiles cannot provide a user with an instant and efficient feel for a legal case and its status. Nor can searching for, finding and reading a found case status or profile be said to provide an exact understanding of what required action is yet to be taken in a case, or which required acts have been carried out, for example, a second demand for documents and things served ten (10) days past and requiring documents by a return date, responsiveness to which requiring numerous acts and communications coordinated with law firm personnel.

### SUMMARY OF THE INVENTION

A case management system with automatic document update ability and method for using the system are disclosed hereby that overcome the shortcomings of known legal case management systems and application programs.

In one embodiment, the inventive case management system is arranged to code or assign a document identifier referred to as an update file extension to each document or document image entered and stored in association with a legal case. The system operates with these update file extensions to carry out automatic update tasks and to provide an instant feel for a case status in cooperation with a file manager. As such, the assignment of the document's file update extension profiles the document within the context of its associated legal case.

As used herein, the terms document and document file are meant to represent any electronic data file containing any type of data that relates to a legal case in any format, e.g., a record, an email communication, a discovery document, a photograph, a photographic image, a radiographic image, a letter, a litigation paper, etc., without limitation. A document's filename as used herein is meant to convey the electronic name given to an entered and stored document or document file, which typically includes a file extension identifying the file type or format.

The update file extension that is appended to each document file is correlated to the document's function in the context of the legal case to which it relates, and by virtue of its existence in the file system, the update file extension inherently implies a process state or status of the case. The update file extension is appended to a document's filename in a process by which a document is entered into a system or network. The update file extension may replace or be appended to a traditional document filename extension.

In an embodiment, the processing required to code the update file extensions to documents as they are entered is implemented by a novel document identifier function in cooperation with a known conventional document entry functions, for example, the Worldox™ document entry function. A drop down box is automatically presented that requires the user to input data defining the document type by the update file extension, as a condition for entering the document into the system/network.

By providing all documents entered into a network or system with an update file extension, all filenames of all documents in a particular legal case file folder are readily identifiable in'a window or display image presented by the network file management system, e.g., Windows Explorer™, providing the viewer with an instant feel for a case's progress or status to date. That is, a glance at a legal case folder or sub-folder displaying the filenames or icons identifying document files with the update file extensions allows for instant recognition of an accumulated state of a case.

In an alternative embodiment, a combined document entry and document identifier function operates as follows. After highlighting a document of any known type, whether previously entered or currently entered, using an input device (for example, moving a cursor onto a document using “MyDocuments”), the user then clicks on and activates a special “Legal Document Entry” button. This activation causes the system to automatically generate and present an interactive display image that includes lists, and sub-lists of update file extensions from which the user chooses an appropriate update file extension. In a variation, a drop down menu may be presented for the creation of a “legal document cover sheet record” or profile that is linked to the document being entered.

A display processor function presents the legal document cover sheet record as an interactive display image with fields requiring user input. The user then enters the requested data in the respective fields. Based on the data input, the system automatically identifies the entered document as one of any of the predefined document type definitions, and codes or assigns to the document with an appropriate update file extension for the type definition. Upon completion and entry of the legal document cover sheet record, the system automatically responds by storing the record, storing the document and taking the appropriate automatic document action, where necessary. documents cooperate with an automatic update function. In one embodiment, upon document entry into the system, the document's update file extension triggers system action in accordance with a set of rules associated with the documents types. The document update function cooperates with a rules engine configured with the rules. An IT professional configures the system or network to operate by the rules as desired by the legal entity or organization. Examples of such automatic action include automatically generating and sending electronic communications such as notifications, requests for actions, requests for payments, updates to calendar functions, etc, without limitation.

In an embodiment, the invention provides a case management system for managing case documents within a network that presents case document folder views by which a viewer receives and instant case status. The system includes a computer processor configured for managing entry of case documents in cooperation a network management device including operating a document entry function and document viewing function and a database coupled to and configured to cooperate with the computer processor to store and retrieve the documents. The document entry function codes an update file extension to every document entered within the Network, which update file extension is correlated to a case legal function to which the document is associated. The document viewing function cooperates with a Network file management and display functions to present case folder views that display case documents to highlight respective document update file extensions thereby communicating case status.

In another embodiment, the invention includes a case management method implemented by a computer processor for automatically controlling document-related operations within a plurality of data processing devices or computers connected and organized as an electronic network. The meted includes automatically generating a request for an update file extension upon detection of a command to enter a document into the electronic network, inputting a response to the request including coding the document with an update file extension and entering and storing the document within the network in association with a filename identifier that includes the update file extension.

In another embodiment, the invention includes a program storage device readable by a computer processor or machine, tangibly embodying a program of instructions executable by the computer processor or machine comprising a case management method for automatically controlling document-related operations within a plurality of data processing devices or computers connected and organized as an electronic network, the method comprising the steps or acts as defined above.

### BRIEF DESCRIPTION OF THE DRAWINGS

The present invention can best be understood in connection with the accompanying drawings. It is noted that the invention is not limited to the precise embodiments shown in drawings, in which:

FIG. 1 depicts a general purpose computer configured as a case management system with document update ability;

FIG. 2 depicts the computer configured in accordance with the invention shown in FIG. 1 arranged in a Network with a relational database and gateway for Internetwork operation;

FIG. 3 depicts one embodiment of a legal document cover sheet record for use with the invention; and

FIG. 4 depicts a functional description of the case management system with document update ability; and

FIG. 5 is a flow chart depicting the functional flow of a method of the invention.

### DETAILED DESCRIPTION OF THE INVENTION

The following is a detailed description of example embodiments of the invention depicted in the accompanying drawings. The example embodiments are in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

The case management system with automatic update ability is reliant upon proper identification of the documents that are found in any system or network messaging, for example, conventional paper mail. Once a message (i.e., conventional email or conventional mail) is received at any network location (Infra- or Internetwork), its contents must be properly entered (e.g., scanned) and coded with an update file extension. This can be done in several ways, as will be described in further detail below, including automatically presenting the user with an interactive display image comprising a legal document cover sheet record.

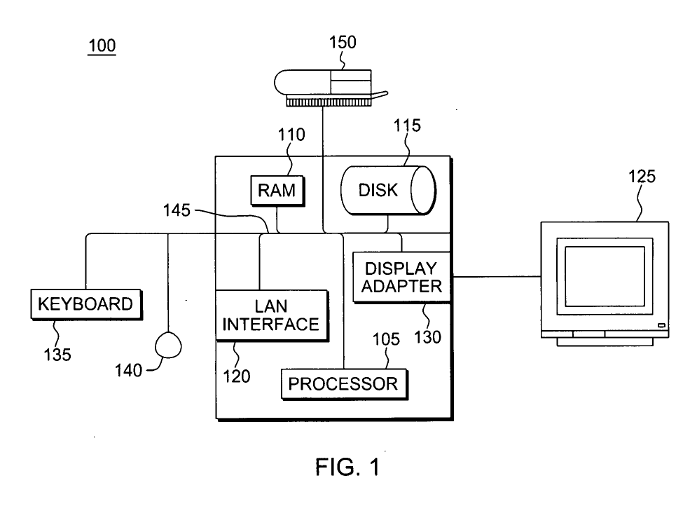

FIG. 1 depicts a general purpose computer (100) that has been downloaded with a set of computer readable instructions (software or an application program), which when operated upon by the general purpose computer, functions to implement control of a case management system with automatic document update ability. The computer (100) preferably includes a processor (105), which may, for example, run a Windows operating system. The software or application program comprising the case management system control is operated upon by the processor (105) in cooperation with the operating system.

Computer (100) and processor (105) further operate with a short term memory (110), preferably RAM, and a long term memory (115), preferably a hard disk, as known in the art. The computer (100) further includes a LAN interface (120), a display (125), a display adapter (130), a keyboard (135), a mouse (140), a bus (145) and a printer (150), as known in the art. The software or application program instructions comprising the case management system control may be downloaded to the computer (100) and stored in RAM (110), long term memory (115) or memory storage means other than long term memory (115), within which the data comprising the database and the database instance may be stored, as long as they are accessible by the processor.

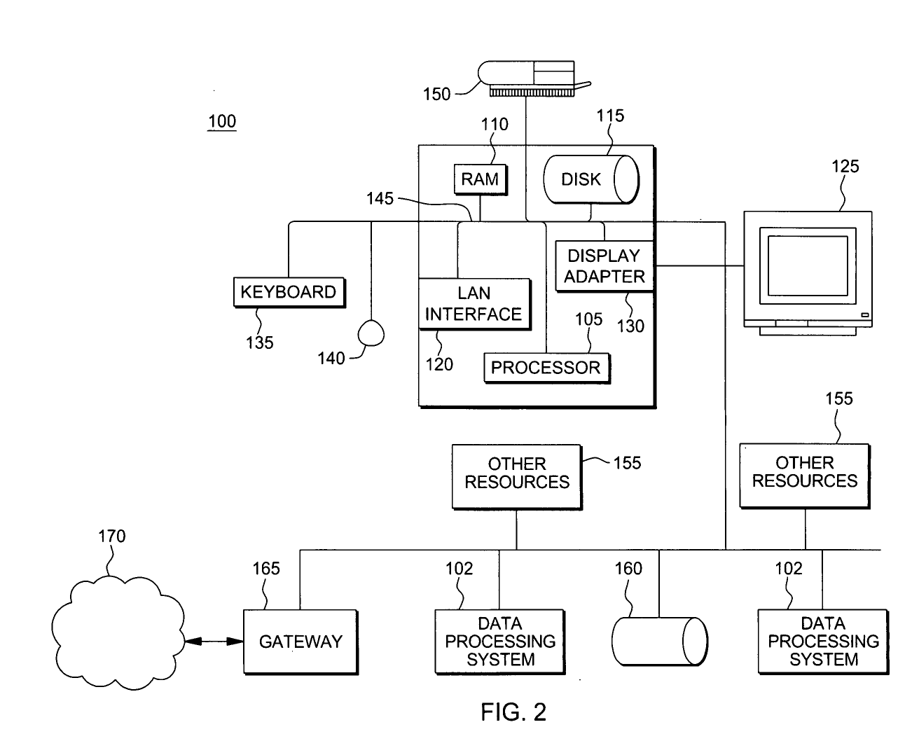

FIG. 2 shows the general purpose computer (100) operating case management system control physically connected to a number of computers or data processing systems (102) and to a number of other resources (155) via LAN bus (145). In the FIG. 2 arrangement, general purpose computer (100) operates or controls the case management system to meet the entire network needs in accordance with the inventive principles. Also connected to LAN bus (145) as part of the case management system is a database (160), preferably a relational database, and a gateway (165), which connects all network resources to the Internet (170).

While the database (160) is represented in the figure as a conventional database comprising a fixed storage medium, the database may be distributed about the network and connected by LAN bus (145), may be distributed at off-network locations, for example, in the cloud, or some combination of Inter- and intra-network distributed locations/devices or may merely reside in storage means directly accessible by computer (100). Moreover, while the network is shown hardwired and interconnected via LAN bus (145), the invention is not limited to operation within a hard-wired network but may operate within a wireless network in accordance with its protocol requirements and in cooperation with its network controller.

All data, for example, email (your email client), entering and leaving the Network, as well as any VOIP data, must pass though the gateway (165), which is typically controlled by an SMTP server (outgoing) and POP3 or IMAP server (incoming) in cooperation with the network controller, for example, Windows NT. The case management system including the automatic update functionality cooperates with the network communication servers to implement the automatic actions in response to entry of documents with particular update file extension based on the rules configuration. Entry as used herein means electronic entry of traditional paper documents by first scanning, or by electronic downloading or storing of electronic documents.

A messaging function is operated by the system to automatically generate and send messages (for example, emails) to notify law firm personnel in response to documents entered with particular update file extensions. The messaging function may include a secondary function by which all email entering and leaving the network is processed to identify documents attached thereto whose file identifiers include an update file extension. That is, upon identifying a document in an email with an update file extension, the case management system automatically records the action; for example, by updating a case file history record associated with the attached document's update file extension, i.e., numbering/classification.

Preferably, the messaging function operates another function by which any documents found attached to Inter- and Intra-network email communications, or email messages containing particular key words, are presented to a designated user to determine whether the documents or messages should be entered to the system with an update file extension in association with a legal case file. Automatically identifying and extracting such documents and/or information from electronic mail (incoming and outgoing) and automatically updating a case file will streamline the work process in any office that has to process large amounts of electronic mail.

The backbone of the system is the type identifiers (i.e., update file extensions) assigned to the documents. As such, the assignment of the document's file update extension profiles the document within the context of its associated legal case. The list below is one embodiment of update file extension identifier numbering system. As should be readily clear to one skilled in the art, the update file extensions coded to documents generated in association with procedural acts occurring at the beginning of a legal case have lower numbers, which is intuitive. The documents associated with procedural acts or functions occurring at the end of a legal case have correspondingly higher numbers.

Please note that the list of update file extensions is exemplary for the various legal functions presented and for the documents related thereto, but that the list is presented for exemplary purposes, is not exhaustive and is not meant to be limiting in any way:

Investigation

| | |
|---|---|
| 100. | Authorization |
| 101. | Retainer |
| 102. | OCA Opening Statement |
| 103. | Police Report |
| 104. | Photos |
| 105. | Witness Statements |
| 105.1 | Property Damage Estimates |
| 106. | Questionairres |
| 107. | OCA Card |
| 108. | Investigator's Report |
| 109. | Property Asset Search Report |
| 110. | Legal Research |
| 111. | Notes |
| 112. | Uncategorized |

Correspondence

| | |
|---|---|
| 200. | Client |
| 201. | Health Care Provider |
| 201.1 | Lien |
| 202. | Insurance Company |
| 203. | Other Attorney |
| 204. | Court |
| 205. | Uncategorized |

Medical Records/EOB

| | |
|---|---|
| 300. | Medical Record/Hospital Record |
| 301. | Medical Bill from Provider |
| 302. | Medical Bill from Client |
| 303. | Narrative Report |
| 304. | Expert Report |
| 305. | No-Fault PIP Application |
| 306. | No Fault Record |
| 306.1 | Workers Compensation Record |
| 307. | EOB (Explanation of Benefits) or Denial of Benefits (DOB) |
| 308. | Pre-Certification Notice |
| 309. | Employment Record/Tax Return |
| 310. | Defense Exam Notice |
| 311. | Defense IME, Liability Exam Report |
| 312. | PIP IME, PIP Exam Report |
| 313. | Uncategorized |

Legal Documents

| | |
|---|---|
| 400. | Permanency Certification |
| 400.1 | Notice of Claim |
| 401. | Summons |
| 402. | Complaint |
| 403. | Proof of Service |
| 403.1 | Stip to Extend |
| 403.2 | Dismissal Notice |
| 404. | Answer |
| 405. | Interrogatories, Form A |
| 406. | Interrogatories, Form C |
| 407. | Bill of Particulars, Plaintiff |
| 408. | Bill of Particulars, Defendant |
| 409. | Discovery Demands |
| 410. | Discovery Responses |
| 411. | Deposition Transcript |
| 412. | Court Orders/Notices |
| 413. | Motions |
| 414. | Subpoena |
| 415. | Request for Admissions/Notice to Admit |
| 416. | Note of Issue |
| 417. | Offer of Judgment |
| 418. | Request for Judicial Intervention (RJI) |
| 419. | Case Information Statement (CIS) |
| 420. | Arbitration Statement |
| 421. | Arbitration Award |
| 422. | Trial DeNovo of Arbitration Award |
| 423. | Pre-Trial Exchanges |
| 424. | Other |

Settlement

| | |
|---|---|
| 500. | Release |
| 501. | Stipulation of Dismissal/Discontinuance |
| 502. | Charles Jones |
| 503. | Closing Statement |
| 504. | Settlement Check |
| 505. | Closing OCA card |

Vendors

| | |
|---|---|
| 600. | Outside Counsel |
| 601. | Items Relating to Case (Disbursments) |
| 602. | General Business Bills |

Once the document is properly coded, an update file extension is attached via the document entry function, the case management system will thereafter recognize the document by the update file extension. This can include instantly accessing the document's associated record and/or implementing automatic update function action. That is, system, upon finding a message that includes a document with an assigned update file extension might automatically advise a support person and/or attorney of record for the case of certain action that must be taken. A rules engine operates in cooperation with the database and messaging system, including a set of rules configured by a system administrator to define what action is taken under what circumstances, in cooperation with a document and it coded type identifier.

At the same time the highest numbered update file extension will be displayed in the case management system, which automatically qualifies same. For example, in a legal case where the number associated with an automatic update file extension is in the 100's range, the attorney viewing the file folder in which the document is included will automatically know that the case is still being investigated and that no medical records have been ordered. If the highest number associated with the update file extension is in the 300 range, the attorney viewing the file folder in which the document is included will automatically know that medical records have been ordered, but that the case has not yet been placed into suit.

If the highest number associated with the update file extension is in the 400s, the attorney viewing the file folder in which the document is included will automatically identify that the legal case is in suit. If the case number associated with an automatic update file extension is in the 500s the attorney viewing the file folder in which the document is included will automatically identify by the update file extension that the case has been settled. By the presence of the case documents and their respective update file extensions, attorneys and other law firm personnel will have the ability to run reports based upon the highest number that is displayed in the system.

The case management system with automatic update ability, for example, implemented by computer (100), is preconfigured before operation to operate by a set of rules for a particular law firm and jurisdiction. During operation, the system manages case documents within a standalone computer or computer network in cooperation with the computer or computer network file manager. The file manager then presents case file document folder views by which a viewer familiar with the meaning behind the update file extensions included in each document gains an instant feel for case's legal status.

In an embodiment, the case management system comprises a computer processor configured for managing entry of case documents in cooperation a network management device through operation of a document entry function and document viewing function. A database operational within the computer or network that is configured by the processor operates to store and retrieve the documents. The document entry function codes an update file extension to every document entered within the computer or the computer network. The update file extension is correlated to a case legal function to which the document is associated.

The document viewing function cooperates with a computer or computer network file manager and computer or computer network display functions (for example, a users interface function, to present case folder views that display case document filenames to highlight respective document update file extensions thereby communicating case status in any folder view. During operation, the document entry function presents a drop-down menu that includes a list of update file extensions correlated to case legal functions, which must be identified by the user before the system accepts the document for entry.

The update file extensions are defined in tiered groupings, where each tier of a tiered grouping correlates to a stage in a legal case. Preferably, each of the tier stages are any one of an investigation stage, a correspondence stage, a medical records stage, a discovery stage, a legal documents stage, a settlement stage, a vendor stage and an appeal stage. As such, the assignment of the document's file update extension profiles the document within the context of its associated legal case.

In one embodiment, a case file history record with an update file extension of 10 might include data that highlights the case history from inception, including the law firm file or index number, names of all parties, insurers, witnesses, attorney of record, law firm support personnel, Court Index Number and Judge, Magistrate, law clerk, when assigned, etc., without limitation.

For example, if a police report is received by mail, office personnel can scan and code or assign an update file extension to it as 103 for entry into the system (103. Police Report; based on police investigation). Generating: 69 is an update file extension used to precipitate action in the system to obtain a police report. That is, any document for entry indicating that a police report is available would be assigned an update file extension 59, where the system responds by automatically communicating with an appropriate law firm person to notify them of a need to secure the police report.

Update file extensions that include numbers in the 100s correspond to documents associated with a case investigation stage. Update file extensions in the 200's designate Correspondence, and do not trigger the automatic update function. Update file extensions in the 300's, Medical Records/EOB, are preferably used to describe those documents related to medical records, including defense examinations.

Update file extensions in the 400's, i.e., Legal Documents, are all documents that are entered after a case goes into suit, that is, after the case is filed and receives a Court index or docket number. These 400 based numbers would include any discovery documents, e.g., 403, 404, 418. Other 400 based numbers indicate depositions. Numbers in the 500s, i.e., Settlements, would indicate various stages of settlement negotiations, i.e., settlement documents. The 600 based numbers, i.e., Vendors, are used to designate documents related to outside counsel, disbursements, general business bills, etc.

While not expressly shown, higher number categories, for example, 700, 800, 900, etc., without limitation, could be used for other purposes, as configured by an IT person prior to system operation, e.g., case financial documents.

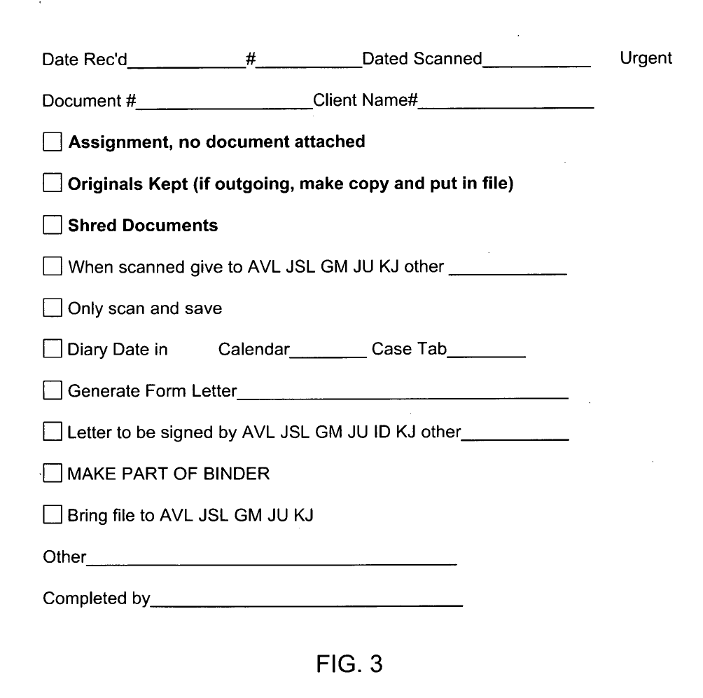

In one implementation, the document entry function presents an interactive document template, comprising a number of fields, including a document update file extension assignment field, where the user must enter data in each field to effectuate document entry. An exemplary embodiment of the interactive document template is depicted in FIG. 3.

Please note, however, that the invention may be implemented using a paper embodiment of a document entry template, which is scanned and saved in a way that identifies the document for entry, and its coded update file extension. The system's novel processing ability identifies the document and any update operations necessary by the update file extension. For that matter, the form of the FIG. 3 interactive document entry template is presented for exemplary purposes only, and not meant to be limiting. Any document entry form to be scanned or interactive document entry may be utilized to enter documents and memorialize the update file extension for operate within the system without deviating from the scope and spirit of the invention, limited only by the claims.

In the embodiment in which the invention utilizes a paper document entry template, and not an automatic document entry function, when a law office receives mail, whether paper or electronic, including documents to be entered, a support person reviews the mail and completes or “fills out” a paper document entry form or scan sheet (e.g., FIG. 3). As already mentioned, this identifies the document to be entered by update file extension, or suffix. Instructions are input directly on the document entry form, and correlate to the update file extension coded. Preferably, an attorney then verifies that the update file extension selection made by the support person for the received document is accurate.

The support person then saves the document with the update file extension and the document entry template or form into the system. Based on the update file extension, the automatic update function then automatically carries out tasks associated. The benefit is that all mail has to be reviewed and saved with an update file extension. It is mandatory for system operation. That is, the invention makes use of the information garnered from that process and automatically updates the case management system. By responding automatically, the system eliminates the need for personnel to determine what acts are required to be carried out in response to mail (i.e., a received document) in cooperation with the update file extension.

For example, a document coded 403 (proof of service) with an update file extension is entered into the system in association with a particular case file. In most jurisdictions, the proof of service is the proof that the defendant has been served. The defendant has 30 days from the date proof of service is received to answer the complaint. An Answer theoretically would be received after the proof of service is coded with an update file extension as 404. Once proof of service is entered as document with update file extension 403, the system (is configured to respond by) automatically seeking a document with an update file extension 404, which is the answer.

If a document with an update file extension coded as 404 is not detected as received by the system a certain date (30 days), the system automatically generates a document, such as motion to enter default, and sends same in a communication to the attorney or staff of record for review (depending on system configuration or the rules). If the document identified with update file extension 404. i.e., the Answer, was received, no further action would be take, that is, no entry to file a motion.

The benefit should be apparent. That is, the automated update function, in cooperation with a document's automatic update function, either automatically enters a diary date, and cancels it or creates a document and communication based upon entry of the received mail document by scanning and coded it with the automatic update extension, avoid the necessity of having to update a case management system by hand, as known in the prior art.

For that matter, while the novel system is configured for updating a particular file as action to be taken in response to a document entered that is coded with a particular update file extension, a plurality of files may be automatically update, or a status of a plurality of files may be checked or verified, all in association with the update file extensions coded thereto. For example, if an attorney wants to determine how many cases there are in the system that have an associated document indicating proof of service (by their coded update file extension), but for which there are no Answers filed (by their coded update file extension), the system allows him to “run a report” for all of his cases were in the highest corresponding legal document update file extension is 403.

The report responds by providing a list of all proof of service documents (update file extensions 403) where there is no subsequent document with a file update extension 404 (or other higher number for that matter, because no update file extension exists out of numerical sequence in the day to day case action.

The attorney may utilize this information received from the identification of the documents and their respective update file extensions, in association with his case files. That is, the update file extension are only part of the file identifiers, which must also include such information as a file name, file type, or other identifiers normally associated with case management systems. That is, the attorney is able to, at a glance, receive a generalized status of all of the files within his office with one key stroke and no longer has to rely on his staff making changes to the case management system.

In one implementation, the document viewing function presents the documents in folders and sub-folders that correlate both to a stage of a case and a set or sub-set of related document file update extensions associated said case stage, and wherein the largest numbers in any sequence of update file extensions represent most recent document activity and therefore legal case activity.

The document update function initiates automatic action upon document entry in accordance with particular update file extensions. That is, some of the file extensions will precipitate automatic action in response to a document entry, and some will not. The automatic action includes determining a manager of the legal case to which the document and document update extension is associated, and generating an email notification to the manager. An email notification to the manager includes the document and indicates tasks for execution in association therewith. The responsive action includes opening or updating a docket status file associated with a legal case.

The determination of how a document is to be saved, which tasks are automatically performed by the system in response to an update file extension upon document entry is a function of the document's profile, and the rules associated with the update file extension related thereto. As mentioned, the rules engine is preconfigured to carry out the particular system update operations related to any update file extension number coded in accordance hereto.

Some of the automatic update tasks include coding tasks to law firm personnel through automatic emails to the network location, automatic message generation to other system resources to precipitate subsequent automatic action thereby, automatically creating a “legal document cover sheet record” or profile, or a docket status file memorializing every transaction associated with a legal case. For example, if a document including an update file extension 412 is entered, an automatic update response to its update file extension and entry might be an automatic email to a law clerk of record in the associated legal case requiring him/her to physically find a document in the 200 range. An example of the letter might be an email with a 5 day old date stamp.

A legal case tracking function may carry out such an action, where document entries, update file extensions, dates and actions taken in response thereto are memorialized. The time for which such documents are saved is defined in the system pre-configuring stage.

Preferably, the document update function cooperates with the network management device to track any network communication within which a document with a coded update file extension is attached, and automatically updates a docket status file associated with the legal case with a record of same communication. The action includes setting a flag that will trigger filing of a notification function to issue a notification communication at a future date.

The notification function issues the communication at the fixed date unless documents with particular document update file extensions are entered into the system. For that matter, the computer processor preferably includes a configuration function by which a user access rights configures a rules engine with a set of rules that qualify the document update file extension usage policy for the network.

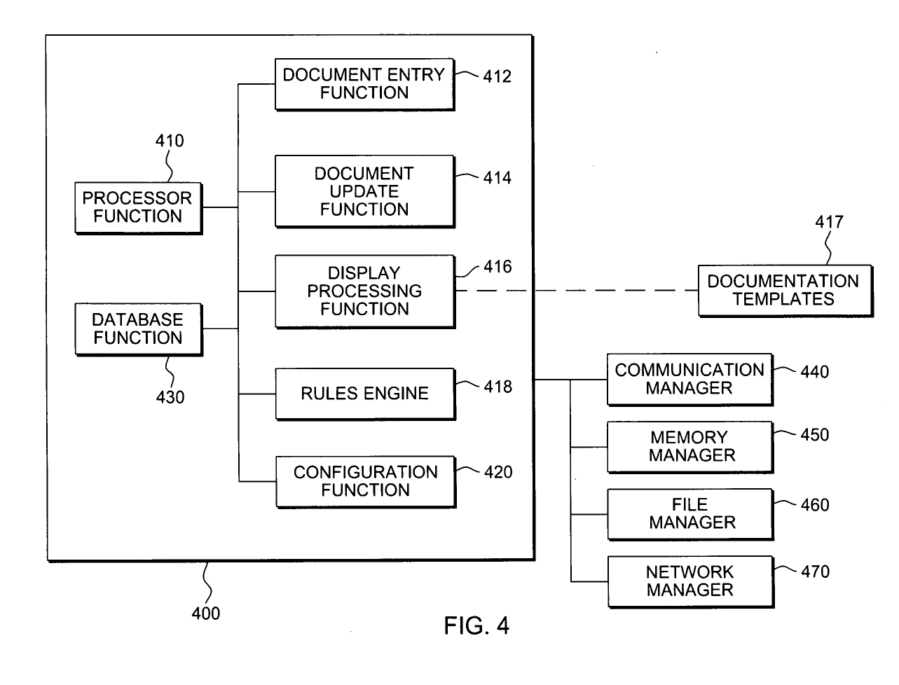

FIG. 4 is a system block diagram in which a case management system (400) with automatic update ability is arranged according to the various functions that the system operates in accordance with the inventive principles.

System (400) includes a processor function (410) shown coupled to database function (430). The processor and database functions are shown coupled to a document entry function (412), a document update function (414), a display processing function (416), a rules engine (418) and a configuration engine (420). The display processing function (416) cooperates with a number of stored document templates, including drop-down menus, document profiles, case history records, etc. without limitation. The system cooperates with various network functions such as a communication manager (440), a memory manager (450), a file manager (460), a network manager (470), without limitation.

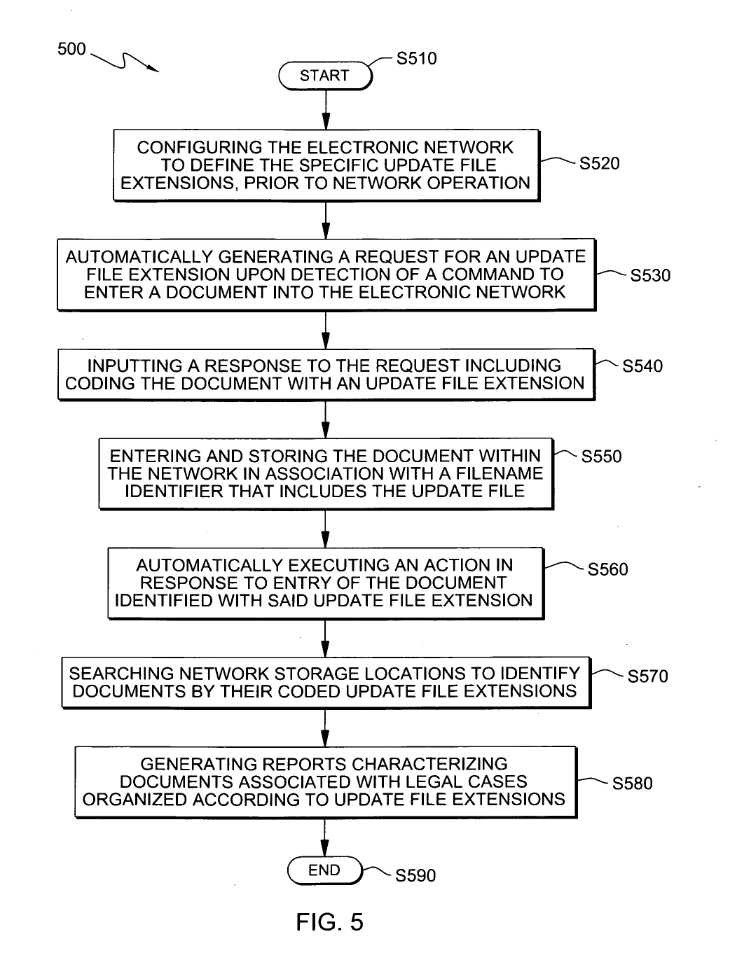

FIG. 5 presents one embodiment of a case management method (500) implemented by a computer processor for automatically controlling document-related operations within a plurality of data processing devices or computers connected and organized as an electronic network of the invention. A start of the method embodiment is indentified by START operator S510. An operation including configuring the electronic network to define the specific update file extensions, prior to network operation, is indicated by operator S520.

An operation including automatically generating a request for an update file extension upon detection of a command to enter a document into the electronic network is identified by operator S530. An operation including inputting a response to the request including coding the document with an update file extension is identified by operator 140. An operation including entering and storing the document within the network in association with a filename identifier that includes the update file extension is identified by operator S550.

An operation including automatically executing an action in response to entry of the document identified with said update file extension is identified by operator 560. An operation including searching network storage locations to identify documents by their coded update file extensions is identified by operator 570. An operation including generating reports characterizing documents associated with legal cases organized according to update file extensions is identified by operator 580

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended

What is claimed is:

1. A case management system for managing case documents within a network that presents case document folder views by which a viewer receives and instant case status, comprising:
a computer processor configured for managing entry of case documents in cooperation a network management device including operating a document entry function and document viewing function; and
a database coupled to and configured to cooperate with the computer processor to store and retrieve the documents;
wherein the document entry function codes an update file extension to every document entered within the Network, which update file extension is correlated to a case legal function to which the document is associated; and
wherein the document viewing function cooperates with a Network file management and display functions to present case folder views that display case documents to highlight respective document update file extensions thereby communicating case status.

2. The case management system as set forth in claim 1, wherein the document entry function presents a drop-down menu that includes a list of update file extensions correlated to case legal functions, which must be identified by the user before the system accepts the document for entry.

3. The case management system as set forth in claim 2, wherein the update file extensions are defined in tiered groupings, where each tier of a tiered grouping correlates to a stage in a legal case.

4. The case management system as set forth in claim 3, wherein each tier stages are any one of an investigation stage, a correspondence stage, a medical records stage, a discovery stage, a legal documents stage, a settlement stage, a vendor stage and an appeal stage.

5. The case management system as set forth in claim 1, wherein the document entry function presents an interactive document template, comprising a number of fields, including a document update file extension assignment field, where the user must enter data in each field to effectuate document entry.

6. The case management system as set forth in claim 1, wherein the document viewing function presents the documents in folders and sub-folders that correlate both to a stage of a case and a set or sub-set of related document file update extensions associated said case stage, and wherein the largest numbers in any sequence of update file extensions represent most recent document activity and therefore legal case activity.

7. The case management system as set forth in claim 1, further comprising a document update function, which initiates automatic action upon document entry in accordance with particular update file extensions.

8. The case management system as set forth in claim 7, wherein the automatic action includes determining a manager of the legal case to which the document and document update extension is associated, and generating an email notification to the manager.

9. The case management system as set forth in claim 8, wherein an email notification to the manager includes the document and indicates tasks for execution in association therewith.

10. The case management system as set forth in claim 7, wherein the responsive action includes opening or updating a docket status file associated with a legal case.

11. The case management system as set forth in claim 10, wherein the document update function cooperates with the network management device to track any network communication within which a document with an coded update file extension is attached, and automatically updates a docket status file associated with the legal case with a record of same communication.

12. The case management system as set forth in claim 7, wherein the action includes setting a flag that will trigger filing of a notification function to issue a notification communication at a future date.

13. The case management system as set forth in claim 12, wherein the notification function issues the communication at the fixed date unless documents with particular document update file extensions are entered into the system.

14. The case management system as set forth in claim 1, wherein the computer processor further comprises a configuration function by which a user access rights configures a rules engine with a set of rules that qualify the document update file extension usage policy for the network.

15. A case management method implemented by a computer processor for automatically controlling document-related operations within a plurality of data processing devices or computers connected and organized as an electronic network, comprising:
automatically generating a request for an update file extension upon detection of a command to enter a document into the electronic network;
inputting a response to the request including coding the document with an update file extension; and
entering and storing the document within the network in association with a filename identifier that includes the update file extension.

16. The case management method as set forth in claim 15, wherein the command associated with automatically generating includes at least one of scanning a document, creating a word processing document, downloading an image file, extracting a document from an incoming email communication, downloading a document from a web site, creating an HTML document and creating a XML document.

17. The case management method as set forth in claim 15, wherein the automatically generating includes presenting the user with a document entry form or template.

18. The case management method as set forth in claim 17, wherein presenting the user with a document entry form or template includes displaying at least one display screen image with fields arranged for receipt of data associated with the document for entry, including a field for receipt of the update file extension.

19. The case management method as set forth in claim 18, wherein the at least one display screen image provides a user with an option of viewing a list of available update file extensions, including an explanation for each.

20. The case management method as set forth in claim 15, further including automatically executing an action in response to entry of the document identified with said update file extension.

21. The case management method as set forth in claim 20, wherein the automatically executing includes automatically generating an electronic communication at a predetermined time.

22. The case management method as set forth in claim 21, wherein the automatically executing includes automatically generating a support document that is included in the electronic communication, at the predetermined time, which support document includes a filename identifier including a coded update file extension.

23. The case management method as set forth in claim 15, further including searching network storage locations to identify documents by their coded update file extensions.

24. The case management method as set forth in claim 23, wherein the searching includes searching a database of documents using a strategy based on coded update file extensions.

25. The case management method as set forth in claim 15, further including generating reports characterizing documents associated with legal cases organized according to update file extensions.

26. The case management system as set forth in claim 15, further including configuring the electronic network to define the specific update file extensions, prior to network operation.

27. The case management system as set forth in claim 26, wherein the configuring includes defining rules for operating in association with the specified update file extensions.

28. A program storage device readable by a computer processor or machine, tangibly embodying a program of instructions executable by the computer processor or machine comprising a case management method for automatically controlling document-related operations within a plurality of data processing devices or computers connected and organized as an electronic network, comprising:
automatically generating a request for an update file extension upon detection of a command to enter a document into the electronic network;
inputting a response to the request including coding the document with an update file extension; and
entering and storing the document within the network in association with a filename identifier that includes the update file extension.
X-ray imaging system to perform the method steps set forth in claim 33.
